(19) United States
(12) Patent Application Publication
(10) Pub. No.: US 2026/0223225 A1
(43) Pub. Date: Jul. 30, 2026

(54) COMMUNICATION DEVICE, COMMUNICATION METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Hiroki MURAYAMA, Nagano (JP)

(21) Appl. No.: 19/460,418

(22) Filed: Jan. 27, 2026

(30) Foreign Application Priority Data
Jan. 29, 2025 (JP) 2025-012818

(51) Int. Cl. H04W 76/15; H04N 1/00

(52) U.S. Cl. CPC H04W 76/15; H04N 1/00204

(57) ABSTRACT

A communication device includes a communication processing section that performs a process for communicating with a first input device and a second input device, a setting section that sets first device identification information; an acquisition section that acquires first input information which is input information input by the first input device; and a transmission processing section that performs a process for transmitting the acquired first input information to a terminal device, wherein the setting section sets the first device identification information for the second input device, the acquisition section acquires second input information which is input information input by the second input device, and the transmission processing section performs a process for transmitting the acquired second input information to the terminal device as the input information from the input device corresponding to the first device identification information.

The present application is based on, and claims priority from JP Application Serial Number 2025-012818, filed January 29, 2025, the disclosure of which is hereby incorporated by reference herein in its entirety.

### BACKGROUND

### 1. Technical Field

The present disclosure relates to a communication device, a communication method, and a non-transitory computer-readable storage medium storing a program.

### 2. Related Art

JP-A-2009-187078 discloses a Point of Sales (POS) device that automatically reads and registers information on a purchased product. The POS device according to JP-A-2009-187078 includes a plurality of barcode scanners. The barcode scanner reads a barcode.

As in the technique described in JP-A-2009-187078, a plurality of input devices such as barcode scanners may be coupled to a communication device. Further, designation identification information, which is identification information designated by a manufacturer, may be set for each of the plurality of input devices. Here, in the service realized by using the communication device and the input devices, the device identification information different from the designation identification information may be set in the input device in order for the terminal device that uses the service to specify the input device that is a control target coupled to the communication device. However, in the technique described in JP-A-2009-187078, there is a concern that the same device identification information cannot be set for a plurality of input devices which are coupled to the communication device and in which the designation identification information is the same with each other.

### SUMMARY

According to an aspect of the present disclosure, there is provided a communication device including: a communication processing section that performs a process for communicating with a first input device and a second input device, which are input devices to which input information is input and which are coupled to the communication device; a setting section that sets first device identification information used in a service of the communication device for the first input device based on first identification information designated by a manufacturer for the first input device; an acquisition section that acquires first input information which is input information input by the first input device; and a transmission processing section that performs a process for transmitting the acquired first input information to a terminal device as input information from an input device corresponding to the first device identification information, in which the setting section sets the first device identification information for the second input device based on comparison between second identification information designated by a manufacturer for the second input device and the first identification information, the acquisition section acquires second input information which is input information input by the second input device, and the transmission processing section performs a process for transmitting the acquired second input information to the terminal device as the input information from the input device corresponding to the first device identification information.

According to another aspect of the present disclosure, there is provided a communication method executed by a communication device, the method including: performing a process for communicating with a first input device and a second input device, which are input devices to which input information is input and which are coupled to the communication device; setting first device identification information used in a service of the communication device for the first input device based on first identification information designated by a manufacturer for the first input device; acquiring first input information which is input information input by the first input device; performing a process for transmitting the acquired first input information to a terminal device as input information from an input device corresponding to the first device identification information; setting the first device identification information for the second input device based on comparison between second identification information designated by a manufacturer for the second input device and the first identification information; acquiring second input information which is input information input by the second input device; and performing a process for transmitting the acquired second input information to the terminal device as the input information from the input device corresponding to the first device identification information.

According to another aspect of the present disclosure, there is provided a non-transitory computer-readable storage medium storing a program executed by a communication device, the program causing a computer to execute: a step of performing a process for communicating with a first input device and a second input device, which are input devices to which input information is input and which are coupled to the communication device; a step of setting first device identification information used in a service of the communication device for the first input device based on first identification information designated by a manufacturer for the first input device; a step of acquiring first input information which is input information input by the first input device; a step of performing a process for transmitting the acquired first input information to a terminal device as input information from an input device corresponding to the first device identification information; a step of setting the first device identification information for the second input device based on comparison between second identification information designated by a manufacturer for the second input device and the first identification information; a step of acquiring second input information which is input information input by the second input device; and a step of performing a process for transmitting the acquired second input information to the terminal device as the input information from the input device corresponding to the first device identification information.

### BRIEF DESCRIPTION OF THE DRAWINGS

FIG. 1 is a diagram illustrating a communication system according to a first embodiment.

FIG. 2 is a diagram illustrating a configuration of a communication device according to the first embodiment.

FIG. 3 is a diagram illustrating a configuration of a terminal device according to the first embodiment.

FIG. 4 is a flowchart illustrating a communication method executed by the communication device according to the first embodiment.

FIG. 5 is a flowchart illustrating a communication method executed by the communication device according to the first embodiment.

FIG. 6 is a flowchart illustrating a communication method executed by the communication device according to the first embodiment.

FIG. 7 is a diagram for describing a communication path in the communication system according to the first embodiment.

FIG. 8 is a diagram illustrating a display screen displayed on the terminal device according to the first embodiment.

### DESCRIPTION OF EMBODIMENTS

### First Embodiment

Hereinafter, an embodiment will be described with reference to the drawings. For clarification of the description, the following description and drawings are appropriately omitted and simplified. In addition, in each drawing, the same elements will be given the same reference numerals, and the redundant description thereof will be omitted as necessary.

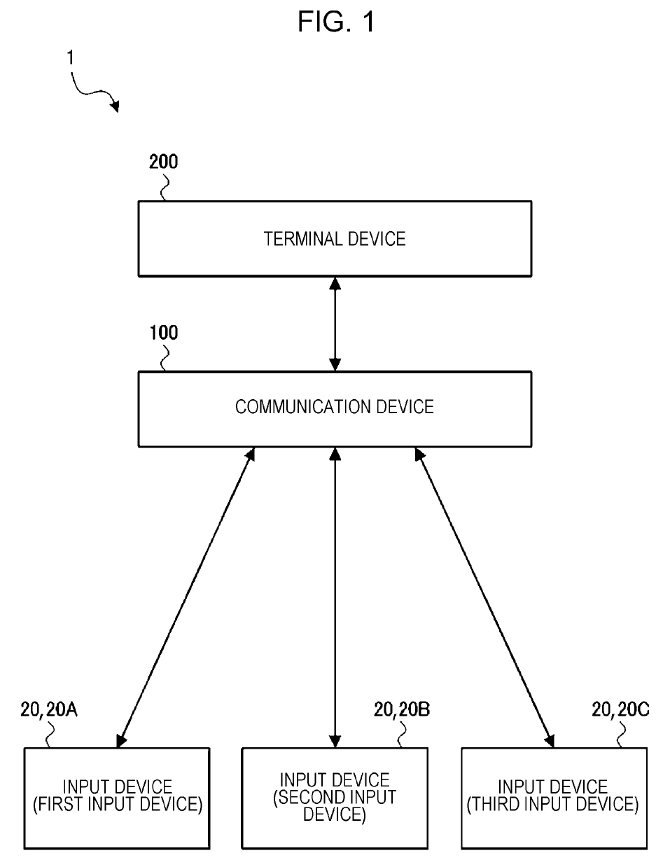

FIG. 1 is a diagram illustrating a communication system 1 according to a first embodiment. The communication system 1 includes a communication device 100, a terminal device 200, and a plurality of input devices 20. The communication device 100 is communicably coupled to the terminal device 200 via a wired or wireless network. The communication device 100 may be coupled to the terminal device 200 via, for example, a wired Local Area Network (LAN) or a wireless LAN. In addition, the communication device 100 can be communicably coupled to each of the plurality of input devices 20. The input device 20 can be coupled to the communication device 100 by, for example, a Universal Serial Bus (USB) standard.

The communication system 1 realizes a service using the communication device 100, the input device 20, and the terminal device 200. For example, the communication system 1 may realize the above service by software executed by the communication device 100. The service realized by the communication system 1 may be, for example, a POS service. In this case, the communication system 1 realizes a POS system. In addition, the terminal device 200 may function as a POS terminal such as a payment terminal. In addition, the input device 20 functions as a peripheral device of the POS system.

The terminal device 200 has a function as a computer including a processor and a memory. The terminal device 200 operates by an OS which is a basic software. The terminal device 200 is a device, such as a Personal Computer (PC), a smartphone, a tablet terminal, or a smart device, used by a user. The terminal device 200 is used to use the above service. In the terminal device 200, an application for making the above service available operates. The application may be a web application or a native application. Details of the terminal device 200 will be described later.

The input device 20 is a peripheral device that is a control target in a service realized by the communication system 1. The input device 20 may have a function as a computer including a processor and a memory. Input information is input to the input device 20. In other words, the input device 20 receives the input information. The input device 20 may be, for example, a scanner that reads information. The input device 20 may be, for example, a code scanner that reads a barcode or a two-dimensional code, or may be a data scan device such as a magnetic card reader. When the scanner is a barcode scanner, the input information is information indicated by the read barcode. In addition, the input device 20 may be a keyboard.

The plurality of input devices 20 are configured with, for example, a first input device 20A, a second input device 20B, and a third input device 20C. It should be noted that the number of input devices 20 included in the communication system 1 is not limited to three.

The communication device 100 has a function as a computer including a processor and a memory. The communication device 100 may execute software for realizing the above service. The communication device 100 communicates with the terminal device 200 and the input device 20. The communication device 100 has a relay function of relaying information exchanged between the terminal device 200 and the input device 20.

In addition, the communication device 100 may be provided with a built-in printer. In this case, the communication device 100 may be a small printer having a relay function. In addition, the communication device 100 may be a hub device having a function of a hub. When the communication device 100 is a hub device, the communication device 100 may not include a printer. In this case, the communication device 100 may be coupled to a printer. The communication device 100 may be coupled to a device other than the input device 20, such as a display, a cash register, or a payment terminal.

Here, the individual input devices 20 are set with device identification information for identifying each device. When the input device 20 is coupled to the communication device 100, the input device 20 transmits the device identification information to the communication device 100. The device identification information may include the designation identification information and the serial number. The serial number is a number unique to each device. Therefore, the serial number can be different for each device.

The designation identification information is identification information designated by a manufacturer for the input device 20. The designation identification information can be appropriately set according to the idea of each manufacturer. For example, the manufacturer may set the same designation identification information in the input devices 20 of the same model or the same type. In this case, the designation identification information may also be referred to as product identification information or model identification information. In addition, for example, the manufacturer may set the same designation identification information in the input devices 20 of the same product group or the same model. In addition, for example, the manufacturer may set the same designation identification information in the input devices 20 having the same communication interface. In addition, for example, the manufacturer may set the same designation identification information in the input devices 20 having the same communication specifications. When the input device 20 is a USB device coupled to the communication device 100 according to the USB standard, the designation identification information may include a Vendor ID (VID) and a Product ID (PID). It should be noted that the designation identification information is different from the serial number. That is, the serial number is set individually for each input device 20. Therefore, even when the designation identification information of the plurality of input devices 20 is the same with each other, the serial numbers of the respective input devices 20 are different from each other. It should be noted that there may be devices that do not have a serial number. That is, the device identification information may not include the serial number.

The first identification information is set as the designation identification information in the first input device 20A. The second identification information is set as the designation identification information in the second input device 20B. The third identification information is set as the designation identification information in the third input device 20C. The first identification information is designation identification information designated by a manufacturer for the first input device 20A. The second identification information is designation identification information designated by a manufacturer for the second input device 20B. The third identification information is designation identification information designated by a manufacturer for the third input device 20C.

Here, in the example of FIG. 1, it is assumed that the second identification information is the same as the first identification information. On the other hand, it is assumed that the third identification information is different from the first identification information. Each of the first identification information, the second identification information, and the third identification information may include at least one of the vendor ID and the product ID. This is particularly applicable when the first input device 20A, the second input device 20B, and the third input device 20C are coupled to the communication device 100 according to the USB standard.

In addition, as will be described later, the communication device 100 sets device identification information (device ID) for the input device 20 coupled to the communication device 100. The device identification information is used in a service realized by the software of the communication device 100, in which an application operated by the terminal device 200 specifies the input device 20 that is a control target. Here, in the first embodiment, the communication device 100 sets the device identification information in the input device 20 based on the designation identification information. Specifically, the communication device 100 sets the same device identification information for a plurality of input devices 20 having the same designation identification information. On the other hand, the communication device 100 sets different device identification information for a plurality of input devices 20 having different designation identification information.

As described above, in the example of FIG. 1, the second identification information, which is the designation identification information of the second input device 20B, is the same as the first identification information, which is the designation identification information of the first input device 20A. Therefore, the communication device 100 sets the first device identification information, which is the same device identification information, for the first input device 20A and the second input device 20B. On the other hand, the third identification information, which is the designation identification information of the third input device 20C, is different from the first identification information, which is the designation identification information of the first input device 20A. Therefore, the communication device 100 sets the second device identification information, which is the device identification information different from the first device identification information, for the third input device 20C. As described above, the terminal device 200 can control the input devices 20 as the same control target without distinguishing the plurality of input devices 20 set with the same device identification information by the communication device 100 according to the first embodiment performing the process. As a result, convenience is improved. The details will be described below.

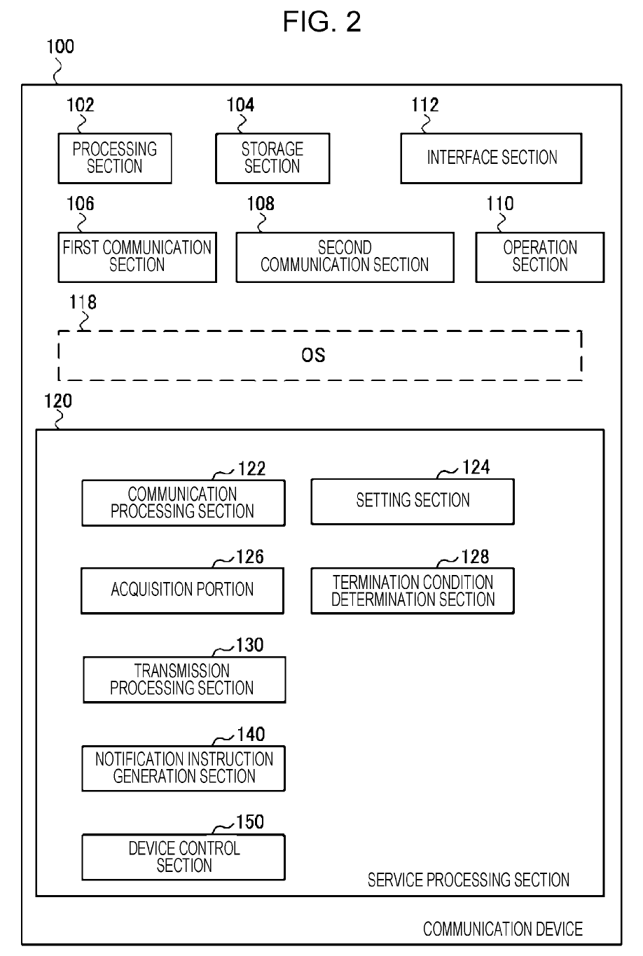

FIG. 2 is a diagram illustrating a configuration of a communication device 100 according to the first embodiment. As a main hardware configuration, the communication device 100 includes a processing section 102, a storage section 104, a first communication section 106, a second communication section 108, an operation section 110, and an interface section 112. The processing section 102, the storage section 104, the first communication section 106, the second communication section 108, the operation section 110, and the interface section 112 may be coupled to each other via a data bus or the like.

The processing section 102 is a processor such as a Central Processing Unit (CPU). The processing section 102 may have a plurality of processors. The processing section 102 has a function as a calculation device that performs a control process, a calculation process, and the like. The processing section 102 controls the storage section 104, the first communication section 106, the second communication section 108, the operation section 110, and the interface section 112.

The storage section 104 is a storage device such as a memory or a hard disk. The storage section 104 is, for example, a Read Only Memory (ROM) or a Random Access Memory (RAM). The storage section 104 has a function of storing a control program, a calculation program, and the like executed by the processing section 102. In addition, the storage section 104 has a function of temporarily storing processing data and the like. The storage section 104 may have a plurality of memories. The storage section 104 may include a database.

The first communication section 106 is a communication device that performs an operation necessary for communication with the input device 20. The first communication section 106 executes communication conforming to, for example, a USB standard. The second communication section 108 is a communication device that performs an operation necessary for communication with the terminal device 200. The second communication section 108 may execute wireless communication conforming to a wireless LAN standard such as a Wi-Fi (registered trademark) standard. The second communication section 108 may be physically integrated with the first communication section 106.

The operation section 110 has an operation function of the communication device 100. When the communication device 100 has a built-in image forming device such as a printer, the operation section 110 may be a printer. That is, the operation section 110 has a printing function for forming an image on a paper, that is, a printing medium. In this case, the operation section 110 includes a printing engine. The printing engine is a mechanical configuration that executes printing of an image on a printing medium. The printing engine may have a mechanism for printing with toner, for example, by an electrophotographic method. Alternatively, the printing engine may have a mechanism for printing by an ink jet method, for example. In addition, the printing engine may have a transport mechanism that transports the printing medium.

The interface section 112 is a user interface. The interface section 112 receives a data input operation performed by the user and outputs information to the user. The interface section 112 may have a display or the like that displays various information to the user. In addition, the interface section 112 may have a keyboard, a button, a mouse, or the like that receives an input operation from the user. In addition, the interface section 112 may have an operation panel such as a touch panel. In addition, the interface section 112 may include an output device such as a speaker. In addition, the interface section 112 may include an input device such as a microphone.

In addition, the communication device 100 includes an Operating System (OS) 118 which is basic software, and a service processing section 120 as components. The OS 118 controls the operation of the service processing section 120. The service processing section 120 is an application software that operates using the function of the OS 118. The service processing section 120 executes the service realized by the communication system 1 described above.

The service processing section 120 includes a communication processing section 122, a setting section 124, an acquisition section 126, a termination condition determination section 128, a transmission processing section 130, a notification instruction generation section 140, and a device control section 150 as components. Each of the above-described components can be realized by, for example, executing a program under the control of the processing section 102. More specifically, each component of the service processing section 120 may be realized by the processing section 102 executing a program stored in the storage section 104. In addition, the necessary program may be recorded on any non-volatile recording medium and installed as necessary to realize each component.

In addition, each component is not limited to being realized by software according to a program, and may be realized by any of combination of hardware, firmware, and software. In addition, each component may be realized by using an integrated circuit, such as a Field-Programmable Gate Array (FPGA) or a microcomputer that can be programmed by a user. In this case, a program configured with each of the components may be realized by using the integrated circuit.

The service processing section 120 performs a process for relaying communication between the input device 20 and the terminal device 200. In addition, the service processing section 120 performs a process for transmitting the input information input to the input device 20 to the terminal device 200. In addition, the service processing section 120 controls the operation section 110 or the input device 20 according to a control command transmitted from the terminal device 200. In the communication device 100, the acquisition section 126, the termination condition determination section 128, and the transmission processing section 130 may function as a relay section that relays the exchange of the information between the input device 20 and the terminal device 200.

The communication processing section 122 performs a communication process necessary for the communication device 100 to communicate with the input device 20. The communication processing section 122 performs a process necessary for the input device 20 to be coupled to the communication device 100. For example, the communication processing section 122 performs a process necessary when a USB standard device is coupled. The communication processing section 122 may perform a communication process by controlling the first communication section 106.

The setting section 124 sets the device identification information for the input device 20 based on the designation identification information designated by the manufacturer for the input device 20. Specifically, the setting section 124 sets any device identification information for the input device 20 first coupled to the communication device 100. In addition, regarding the input device 20 coupled to the communication device 100 next, the setting section 124 sets the device identification information for the input device 20 based on the comparison of the designation identification information of each of the plurality of input devices 20. More specifically, when another input device 20 is coupled to the communication device 100 after a certain input device 20 is coupled to the communication device 100, the designation identification information of the input device 20 coupled later is compared with the designation identification information of the input device 20 coupled first. When the designation identification information of the input device 20 coupled later matches the designation identification information of the input device 20 coupled first, the setting section 124 sets the device identification information set for the input device 20 coupled first for the input device 20 coupled later. On the other hand, when the designation identification information of the input device 20 coupled later is different from the designation identification information of the input device 20 coupled first, the setting section 124 sets the device identification information different from the device identification information set for the input device 20 coupled first, for the input device 20 coupled later.

In the example of FIG. 1, when the first input device 20A is coupled to the communication device 100, the setting section 124 sets the first device identification information for the first input device 20A. Then, when the second input device 20B is coupled to the communication device 100, the setting section 124 compares the first identification information, which is the designation identification information of the first input device 20A, with the second identification information, which is the designation identification information of the second input device 20B. The setting section 124 determines that the first identification information of the first input device 20A and the second identification information of the second input device 20B match. The setting section 124 sets the first device identification information for the second input device 20B. In addition, when the third input device 20C is coupled to the communication device 100, the setting section 124 compares the first identification information of the first input device 20A and the second identification information of the second input device 20B with the third identification information which is the designation identification information of the third input device 20C. The setting section 124 determines that the third identification information is different from the first designation identification information and the second identification information. The setting section 124 sets second device identification information different from the first device identification information for the third input device 20C.

A certain device identification information X is set for an input device X coupled to the communication device 100, and then the input device X is decoupled. Then, it is assumed that the input device X is coupled to the communication device 100 again. In this case, the setting section 124 sets the device identification information X, which is the same as the previously set device identification information, for the input device X. That is, the setting section 124 registers the device identification information set for the input device 20 once coupled in association with the designation identification information of the input device 20. In the above example, the setting section 124 registers the designation identification information X of the input device X and the device identification information X set for the input device X in association with each other. Therefore, when the input device 20 for the designation identification information X is coupled, the setting section 124 sets the device identification information X for the input device 20. This is similarly applied even when the input device X previously coupled to the communication device 100 is coupled to the communication device 100 again, or when the input device 20 different from the input device X but having the same designation identification information X as the input device X is coupled to the communication device 100. On the other hand, when the input device 20 having the designation identification information Y different from the designation identification information X is coupled, the setting section 124 sets the device identification information Y different from the device identification information X for the input device 20.

Here, the communication processing section 122 performs a process for establishing a communication path with the terminal device 200 for the device identification information set by the setting section 124. In other words, the communication processing section 122 establishes a communication path between the input device 20 corresponding to the device identification information and the terminal device 200. Here, the communication processing section 122 establishes one communication path between the plurality of input devices 20 set with the same device identification information and the terminal device 200, instead of a separate communication path. For example, the communication processing section 122 establishes one communication path X corresponding to the device identification information X between the input device X1 and the input device X2, in which the same device identification information X is set, and the terminal device 200. The communication processing section 122 may establish a communication path between the input device 20 corresponding to the device identification information and the terminal device 200 by controlling the first communication section 106 and the second communication section 108.

The acquisition section 126 acquires input information from the input device 20. Specifically, the acquisition section 126 acquires the input information from the input device 20 via the first communication section 106 and the OS 118. More specifically, the acquisition section 126 monitors whether or not the first communication section 106 receives an input from the input device 20. When the plurality of input devices 20 are coupled to the communication device 100, the acquisition section 126 monitors whether or not the first communication section 106 receives the input from each of the plurality of input devices 20. When the first communication section 106 receives the input from the input device 20, the OS 118 outputs an event indicating that the input from the input device 20 is received to the acquisition section 126. The acquisition section 126 acquires the input information transmitted from the input device 20 by reading the input from the input device 20 with the event as a trigger.

At this time, the acquisition section 126 monitors an input device 20 from which the input information is received, the input device corresponding to certain device identification information. For example, when the device identification information X and the device identification information Y are registered, the acquisition section 126 monitors whether or not the input of the designation identification information corresponding to the device identification information X is received from the input device 20 or the input of the designation identification information corresponding to the device identification information Y is received from the input device 20. When the device identification information X corresponds to the input device X1 and the input device X2 and an input is received from the input device X1, the acquisition section 126 determines that the input is received from the input device 20 corresponding to the device identification information X. The acquisition section 126 acquires the input information of the input device X1 which is the input device 20 corresponding to the device identification information X.

The termination condition determination section 128 determines whether or not the termination condition, which is a condition indicating that the acquisition of the input information from the input device 20 is completed, is satisfied. For example, when the input device 20 can add a termination code indicating the termination to the termination of the input information, the termination condition determination section 128 may determine whether or not the termination code is acquired. That is, the termination condition determination section 128 may determine that the termination condition is satisfied for the input information when the termination code is acquired. The termination code may correspond to, for example, a code generated when the Enter key of the keyboard is pressed.

In addition, for example, the termination condition determination section 128 may determine whether or not the input information of the predetermined data amount is acquired. That is, the termination condition determination section 128 may determine that the termination condition is satisfied for the input information when the input information of the predetermined data amount is acquired. Alternatively, the termination condition determination section 128 may determine that the termination condition is satisfied when the termination code is acquired or when the input information of the predetermined data amount is acquired.

The transmission processing section 130 performs a process for transmitting the input information acquired from the input device 20 to the terminal device 200. The transmission processing section 130 may control the second communication section 108 to transmit the input information to the terminal device 200. The transmission processing section 130 performs a process for transmitting the input information, which is determined to satisfy the termination condition by the termination condition determination section 128, to the terminal device 200. When the communication device 100 receives the input information from the plurality of input devices 20 at the same time, the transmission processing section 130 performs a process such that the input information in which the termination condition is satisfied first is transmitted to the terminal device 200 first.

In addition, the transmission processing section 130 transmits the input information to the terminal device 200 via a communication path corresponding to the device identification information corresponding to the input device 20 that transmits the input information. In other words, the transmission processing section 130 transmits the input information to the terminal device 200 as the input device 20 corresponding to the device identification information set in the input device 20 that transmits the input information.

For example, as in the example of FIG. 1 described above, it is assumed that the setting section 124 sets the first device identification information for the first input device 20A and the second input device 20B and sets the second device identification information for the third input device 20C. In this case, the communication processing section 122 establishes a first communication path for the first device identification information between the first input device 20A and the second input device 20B and the terminal device 200. Meanwhile, the communication processing section 122 establishes a second communication path for the second device identification information between the third input device 20C and the terminal device 200.

In this case, it is assumed that the communication device 100 receives the first input information from the first input device 20A. In this case, the transmission processing section 130 performs a process for transmitting the first input information to the terminal device 200 via the first communication path. As a result, the transmission processing section 130 performs a process for transmitting the first input information to the terminal device 200 as the input information from the input device 20 corresponding to the first device identification information. As in the case where the communication device 100 receives the second input information from the second input device 20B, the transmission processing section 130 performs a process for transmitting the second input information to the terminal device 200 via the first communication path. As a result, the transmission processing section 130 performs a process for transmitting the second input information to the terminal device 200 as the input information from the input device 20 corresponding to the first device identification information. That is, when the input information is transmitted from any one of the plurality of input devices 20 corresponding to the same device identification information, the transmission processing section 130 transmits the input information to the terminal device 200 as the input information from a simple “input device” without distinguishing the plurality of input devices 20.

Depending on the content of the service, it may be preferable that the terminal device 200 determines which of the plurality of input devices 20 set with the same device identification information has transmitted the input information. In that case, the transmission processing section 130 performs a process for transmitting the input information and the serial number of the input device 20 that transmits the input information to the terminal device 200. In the example of FIG. 1, the transmission processing section 130 performs a process for transmitting the serial number of at least one of the first input device 20A and the second input device 20B and the input information to the terminal device 200. As a result, even when the transmission processing section 130 transmits the input information to the terminal device 200 via the same communication path, the terminal device 200 can determine which input device 20 has input the input information.

The notification instruction generation section 140 generates a notification instruction that is an instruction to notify the terminal device 200 of the input device information that is information regarding the input device 20. The input device information is information regarding the input device 20 associated with each of the device identification information. In the example of FIG. 1, the notification instruction generation section 140 may generate the notification instruction to notify the terminal device 200 of the input device information regarding the first input device 20A and the second input device 20B, which are input devices 20 associated with the first device identification information. The notification instruction may include the input device information and a command for causing the terminal device 200 to output the input device information. The transmission processing section 130 performs a process for transmitting the notification instruction to the terminal device 200. In the example of FIG. 1, the transmission processing section 130 performs a process for transmitting, to the terminal device 200, the notification instruction to notify the terminal device 200 of the input device information regarding the first input device 20A and the second input device 20B associated with the first device identification information. When the communication device 100 receives a request for the input device information from the terminal device 200, the transmission processing section 130 may transmit the notification instruction to the terminal device 200.

The device control section 150 acquires a control command from the terminal device 200 to instruct the control of the device. The device control section 150 may acquire the control command by, for example, the second communication section 108 receiving the control command from the terminal device 200. The device control section 150 controls the device according to the control command from the terminal device 200. Specifically, the device control section 150 controls the operation section 110, which is a printer, according to a print command when the print command is received as the control command from the terminal device 200. In addition, the device control section 150 controls the input device 20 according to the equipment control command when the device control section 150 receives an equipment control command as the control command from the terminal device 200.

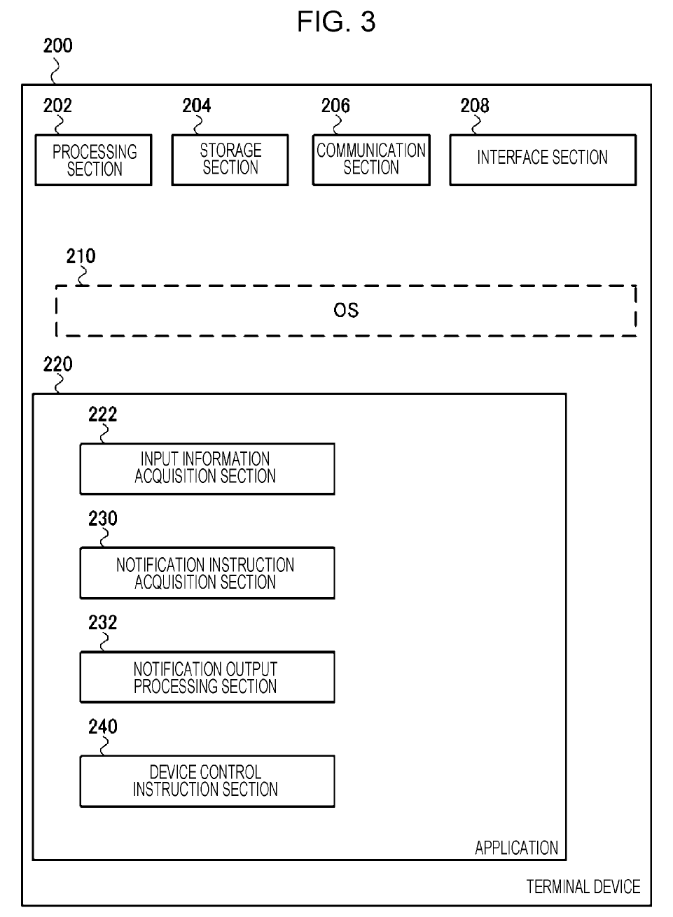

FIG. 3 is a diagram illustrating a configuration of a terminal device 200 according to the first embodiment. As a main hardware configuration, the terminal device 200 includes a processing section 202, a storage section 204, a communication section 206, and an interface section 208. The processing section 202, the storage section 204, the communication section 206, and the interface section 208 may be coupled to each other via a data bus or the like.

The processing section 202 is, for example, a processor such as a CPU. The processing section 202 may have a plurality of processors. The processing section 202 has a function as a calculation device that performs a control process, a calculation process, and the like. The processing section 202 controls the storage section 204, the communication section 206, and the interface section 208.

The storage section 204 is a storage device such as a memory or a hard disk. The storage section 204 is, for example, a ROM, a RAM, or the like. The storage section 204 has a function of storing a control program, a calculation program, and the like executed by the processing section 202. In addition, the storage section 204 has a function of temporarily storing processing data and the like. The storage section 204 may have a plurality of memories. The storage section 204 may include a database.

The communication section 206 is a communication device that performs an operation necessary for communication with the communication device 100. The communication section 206 may execute wireless communication conforming to a wireless LAN standard such as a Wi-Fi (registered trademark) standard.

The interface section 208 is a user interface. The interface section 208 receives a data input operation performed by the user and outputs information to the user. The interface section 208 may have a display or the like that displays various information to the user. In addition, the interface section 208 may have a keyboard, a button, a mouse, or the like that receives an input operation from the user. In addition, the interface section 208 may have an operation panel such as a touch panel. In addition, the interface section 208 may include an output device such as a speaker. In addition, the interface section 208 may include an input device such as a microphone.

In addition, the terminal device 200 includes an OS 210 which is a basic software, and an application 220 as a component. The OS 210 controls the operation of the application 220. The application 220 is an application software that operates using the function of the OS 210. The application 220 is used for a user to use a service realized by the communication system 1 described above.

The application 220 includes an input information acquisition section 222, a notification instruction acquisition section 230, a notification output processing section 232, and a device control instruction section 240 as components. Each of the above-described components can be realized by, for example, executing a program under the control of the processing section 202. More specifically, each component can be realized by the processing section 202 executing a program stored in the storage section 204. In addition, the necessary program may be recorded on any non-volatile recording medium and installed as necessary to realize each component.

In addition, each component is not limited to being realized by software according to a program, and may be realized by any of combination of hardware, firmware, and software. In addition, each component may be realized by using an integrated circuit such as an FPGA or a microcomputer that can be programmed by a user. In this case, a program configured with each of the components may be realized by using the integrated circuit.

The input information acquisition section 222 acquires the input information from the communication device 100. The input information acquisition section 222 may acquire the input information by, for example, the communication section 206 receiving the input information. Here, the input information acquisition section 222 acquires the input information via the communication path established by the communication device 100 as described above. Therefore, the input information acquisition section 222 determines an input device 20 from which the input information is acquired, the input device corresponding to certain device identification information. In other words, the input information acquisition section 222 does not have to determine which input device 20 among the plurality of input devices 20 corresponding to the same device identification information the acquired input information is from. For example, as in the example of FIG. 1, it is assumed that the first input device 20A and the second input device 20B are associated with the first device identification information, and the input information acquisition section 222 acquires the input information of any of the first input device 20A and the second input device 20B. In this case, the input information acquisition section 222 acquires the input information via the communication path corresponding to the first device identification information when the device that transmits the input information is any of the first input device 20A and the second input device 20B. The input information acquisition section 222 acquires the input information as the information from the input device 20 associated with the first device identification information. When the terminal device 200 acquires the serial number of the input device 20 together with the input information, it should be noted that the input information acquisition section 222 can determine from which input device 20 among the plurality of input devices 20 corresponding to the same device identification information the input information is transmitted.

The notification instruction acquisition section 230 acquires the notification instruction from the communication device 100. The notification instruction acquisition section 230 may acquire the notification instruction by, for example, the communication section 206 receiving the notification instruction from the communication device 100.

The notification output processing section 232 performs a process for outputting the notification of the input device information regarding the input device 20 associated with the device identification information in response to the notification instruction. Specifically, the notification output processing section 232 controls the interface section 208 to output the input device information regarding the input device 20 associated with the device identification information. For example, the notification output processing section 232 may display, on the interface section 208, a display screen representing a list of the input devices 20 corresponding to the device identification information. A specific example of the display screen will be described later.

The device control instruction section 240 performs a process for controlling the device. Specifically, the device control instruction section 240 generates a control command for controlling the device. In addition, the device control instruction section 240 performs a process for transmitting a control command to the communication device 100. The device control instruction section 240 may control the communication section 206 to transmit the control command to the communication device 100.

The device control instruction section 240 may specify the control target device by using the device identification information. For example, the device control instruction section 240 may specify the device identification information set in the input device 20 that has transmitted the acquired input information as the control target. The device control instruction section 240 may generate a control command for the input device 20 corresponding to the device identification information specified as a control target. For example, in the example of FIGS. 1 and 3, it is assumed that the input information acquisition section 222 has acquired the input information from the first input device 20A. In this case, the device control instruction section 240 may specify the input device 20 corresponding to the first device identification information as a control target. In this case, the first input device 20A and the second input device 20B corresponding to the first device identification information are control targets. The device control instruction section 240 performs a process for transmitting, to the communication device 100, the control command for the input device 20 corresponding to the first device identification information. As a result, the device control instruction section 240 can transmit the control command without distinguishing between the first input device 20A and the second input device 20B.

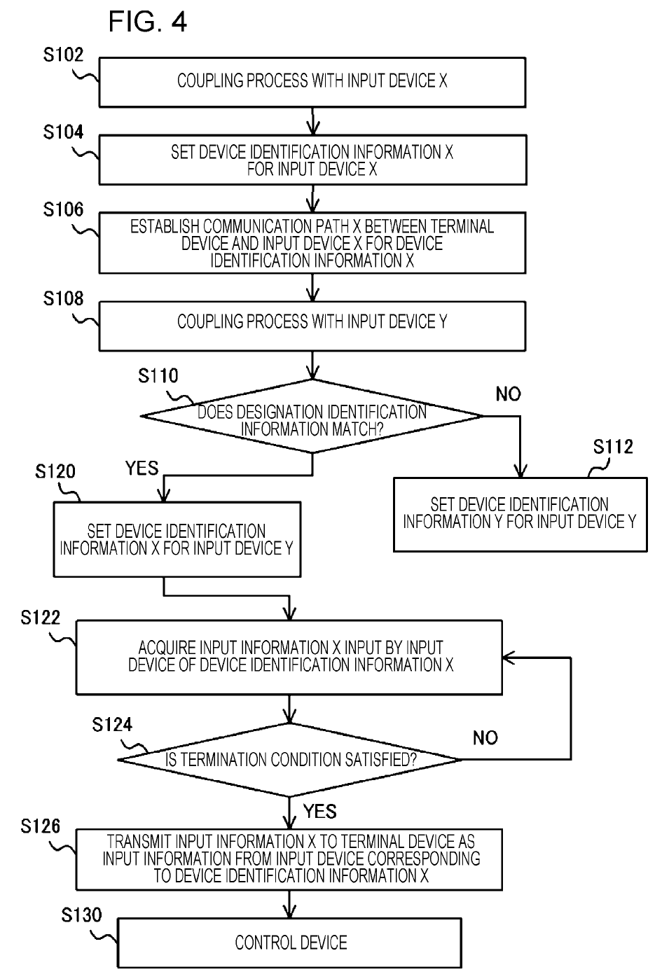

FIGS. 4 to 6 are flowcharts illustrating a communication method executed by the communication device 100 according to the first embodiment. In the flowchart illustrated in FIG. 4, the communication processing section 122 of the communication device 100 performs a coupling process with the input device X, which is the input device 20, as described above (step S102). At this time, the communication processing section 122 acquires the designation identification information X of the input device X. As described above, the setting section 124 of the communication device 100 sets the device identification information X associated with the designation identification information X of the input device X for the input device X (step S104). As described above, the communication processing section 122 of the communication device 100 establishes the communication path X between the terminal device 200 and the input device X for the device identification information X (step S106).

Next, the communication processing section 122 of the communication device 100 performs a coupling process with the input device Y, which is the input device 20, as described above (step S108). At this time, the communication processing section 122 acquires the designation identification information Y of the input device Y. The setting section 124 of the communication device 100 determines whether or not the designation identification information matches (step S110). Specifically, the setting section 124 compares the designation identification information Y of the input device Y with the designation identification information X of the coupled input device X to determine whether or not the designation identification information Y matches the designation identification information X.

When the designation identification information Y does not match the designation identification information X (NO in S110), the setting section 124 sets the device identification information Y different from the device identification information X for the input device Y. The communication device 100 and the terminal device 200 perform a process for distinguishing the input device Y associated with the device identification information Y from the input device X associated with the device identification information X.

On the other hand, when the designation identification information Y matches the designation identification information X (YES in S110), the setting section 124 sets the device identification information X for the input device Y (step S120). At this time, the communication processing section 122 of the communication device 100 establishes a communication path between the terminal device 200 and the input device Y for the device identification information X as in the process of S106. That is, the communication processing section 122 sets the communication path between the input device Y and the terminal device 200 as the communication path X established in the process of S106.

As described above, the acquisition section 126 of the communication device 100 acquires the input information X input by the input device 20 associated with the device identification information X (step S122). The input information X to be acquired may be input information of the input device X, input information of the input device Y, or both of them. The termination condition determination section 128 of the communication device 100 determines whether or not the termination condition is satisfied (step S124) as described above. When the termination condition is not satisfied (NO in S124), the process of S122 is repeated.

On the other hand, when the termination condition is satisfied (YES in S124), the transmission processing section 130 of the communication device 100 performs a process for transmitting the input information X to the terminal device 200 as the input information from the input device 20 corresponding to the device identification information X (step S126). When the input information is acquired from both the input device X and the input device Y, the transmission processing section 130 transmits the input information of the one that satisfies the termination condition in advance. For example, when the termination condition is satisfied in advance for the input information from the input device X, the transmission processing section 130 transmits the input information of the input device X to the terminal device 200 in advance.

In addition, when the communication device 100 receives the control command from the terminal device 200, the device control section 150 of the communication device 100 controls the device according to the control command as described above (step S130). At this time, the control command designates the input device 20 that is a control target by using the device identification information.

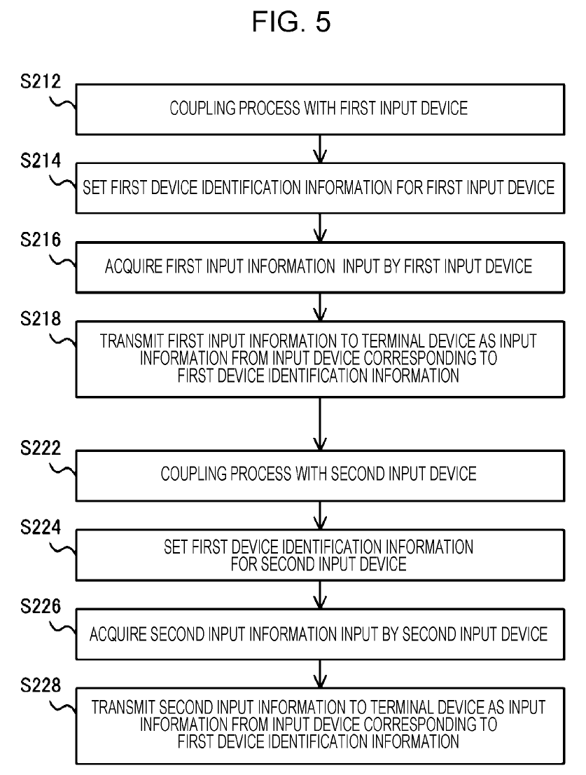

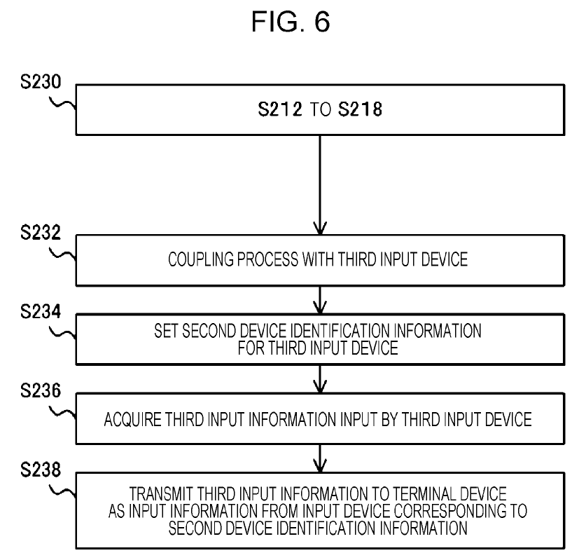

FIGS. 5 to 6 illustrate a communication method for the example illustrated in FIG. 1. In the flowchart illustrated in FIG. 5, the communication processing section 122 of the communication device 100 performs a coupling process with the first input device 20A (step S212). That is, the communication processing section 122 performs a process for communicating with the first input device 20A. At this time, the communication processing section 122 acquires the first identification information which is the designation identification information of the first input device 20A. The setting section 124 of the communication device 100 sets the first device identification information for the first input device 20A based on the first identification information (step S214). At this time, the communication processing section 122 establishes the first communication path, which is a communication path between the terminal device 200 and the first input device 20A, for the first device identification information.

The acquisition section 126 of the communication device 100 acquires the first input information, which is the input information input by the first input device 20A (step S216). The transmission processing section 130 of the communication device 100 performs a process for transmitting the acquired first input information to the terminal device 200 as the input information from the input device 20 corresponding to the first device identification information (step S218). That is, the transmission processing section 130 performs a process for transmitting the acquired first input information to the terminal device 200 via the first communication path corresponding to the first device identification information. Here, when the termination condition determination section 128 determines that the termination condition is satisfied for the first input information, the transmission processing section 130 transmits the first input information to the terminal device 200.

The communication processing section 122 of the communication device 100 performs a coupling process with the second input device 20B (step S222). That is, the communication processing section 122 performs a process for communicating with the second input device 20B. At this time, the communication processing section 122 acquires the second identification information which is the designation identification information of the second input device 20B. Then, the setting section 124 of the communication device 100 sets the first device identification information for the second input device 20B based on the comparison between the second identification information and the first identification information (step S224). That is, since the setting section 124 determines that the second identification information matches the first identification information, the setting section 124 sets the first device identification information set for the first input device 20A for the second input device 20B. That is, the setting section 124 sets the first device identification information for the second input device 20B when the second identification information and the first identification information match.

The acquisition section 126 of the communication device 100 acquires the second input information which is the input information input by the second input device 20B (step S226). The transmission processing section 130 of the communication device 100 performs a process for transmitting the acquired second input information to the terminal device 200 as input information from the input device 20 corresponding to the first device identification information (step S228). That is, the transmission processing section 130 performs a process for transmitting the acquired second input information to the terminal device 200 via the first communication path corresponding to the first device identification information. Here, when the termination condition determination section 128 determines that the termination condition is satisfied for the second input information, the transmission processing section 130 transmits the second input information to the terminal device 200.

In the flowchart of FIG. 5, the processes of S222 to S224 may be executed between S214 and S216. The process of S216 and the process of S226 may be executed in parallel. In that case, the process of S228 is executed after the process of S218 is executed to satisfy the termination condition for the first input information. That is, the transmission processing section 130 performs a process for transmitting the first input information to the terminal device 200 after it is determined that the acquisition of the first input information input by the first input device 20A is completed, and then performs a process for transmitting the second input information input by the second input device 20B to the terminal device 200.

In the flowchart illustrated in FIG. 6, the communication device 100 performs substantially the same process as in the above-described S212 to S218 (step S230). That is, the communication device 100 performs the coupling process with the first input device 20A and sets the first device identification information for the first input device 20A.

The communication processing section 122 of the communication device 100 performs a coupling process with the third input device 20C (step S232). That is, the communication processing section 122 performs a process for communicating with the third input device 20C. At this time, the communication processing section 122 acquires the third identification information which is the designation identification information of the third input device 20C. Then, the setting section 124 of the communication device 100 sets the second device identification information for the third input device 20C based on the comparison between the third identification information and the first identification information (step S234). That is, since the setting section 124 determines that the third identification information is different from the first identification information, the setting section 124 sets the second device identification information different from the first device identification information set for the first input device 20A for the third input device 20C. That is, the setting section 124 sets the second device identification information for the third input device 20C when the third identification information is different from the first identification information. At this time, the communication processing section 122 establishes the second communication path, which is a communication path between the terminal device 200 and the third input device 20C, for the second device identification information.

The acquisition section 126 of the communication device 100 acquires the third input information which is the input information input by the third input device 20C (step S236). The transmission processing section 130 of the communication device 100 performs a process for transmitting the acquired third input information to the terminal device 200 as the input information from the input device 20 corresponding to the second device identification information (step S238). That is, the transmission processing section 130 performs a process for transmitting the acquired third input information to the terminal device 200 via the second communication path corresponding to the second device identification information. Here, when the termination condition determination section 128 determines that the termination condition is satisfied for the third input information, the transmission processing section 130 transmits the third input information to the terminal device 200. In the flowchart of FIG. 6, the processes of S232 to S234 may be executed between S214 and S216. The process of S216 and the process of S236 may be executed in parallel.

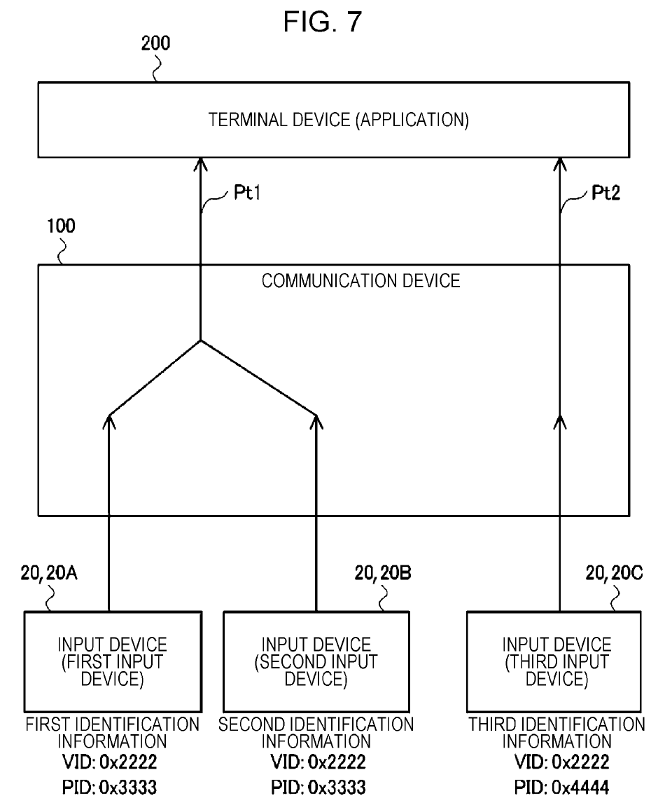

FIG. 7 is a diagram for describing the communication path in the communication system 1 according to the first embodiment. In the example of FIG. 7, the first identification information of the first input device 20A includes “VID: 0x2222” and “PID: 0x3333”. In addition, the second identification information of the second input device 20B includes “VID: 0x2222” and “PID: 0x3333”. In addition, the third identification information of the third input device 20C includes “VID: 0x2222” and “PID: 0x4444”.

Here, in the example of FIG. 7, the second identification information of the second input device 20B matches the first identification information of the first input device 20A. Therefore, the communication device 100 sets the first device identification information, which is the same device identification information, for the first input device 20A and the second input device 20B. Then, the communication device 100 establishes a first communication path Pt1 corresponding to the first device identification information between the first input device 20A and the second input device 20B and the terminal device 200 (application 220).

In addition, the third identification information of the third input device 20C is different from the first identification information of the first input device 20A. Therefore, the communication device 100 sets the second device identification information different from the first device identification information for the third input device 20C. Then, the communication device 100 establishes a second communication path Pt2 different from the first communication path Pt1 between the third input device 20C and the terminal device 200 (application 220) in association with the second device identification information.

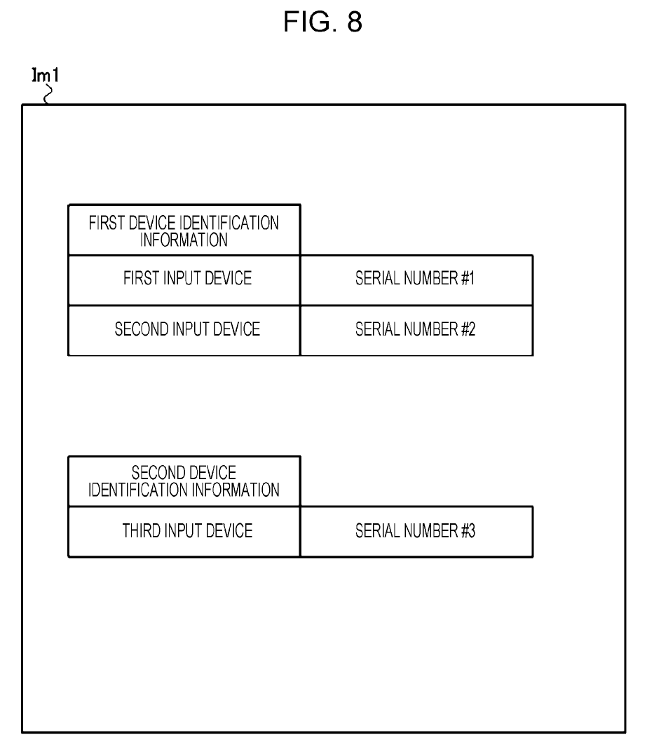

FIG. 8 is a diagram illustrating a display screen Im1 displayed on the terminal device 200 according to the first embodiment. The display screen Im1 is displayed on the interface section 208 by the notification output processing section 232.

The display screen Im1 displays the input device 20 corresponding to the first device identification information and the input device 20 corresponding to the second device identification information. Specifically, the display screen Im1 indicates a serial number #1 of the first input device 20A and a serial number #2 of the second input device 20B as a list of the input devices 20 corresponding to the first device identification information. In addition, the display screen Im1 indicates the serial number #3 of the third input device 20C as a list of the input devices 20 corresponding to the second device identification information. The user can recognize the input device 20 associated with each device identification information by visually recognizing the display screen Im1. In addition, the user can recognize the number of input devices 20 associated with each device identification information. Therefore, convenience is improved.

As described above, the communication device 100 according to the first embodiment is configured to set the device identification information for the input device 20 based on the designation identification information of the input device 20. Therefore, the same device identification information can be set for the plurality of input devices 20 which are coupled to the communication device 100 and in which the designation identification information is the same with each other.

In addition, as a result, in the application 220 of the terminal device 200, the control can be performed on the input device 20 as the input device 20 corresponding to the device identification information without distinguishing the plurality of input devices 20 in which the designation identification information is the same with each other. That is, in the application 220 of the terminal device 200, the input devices 20 in which the designation identification information is the same with each other can be handled without distinguishing the plurality of input devices 20. Here, in the plurality of input devices 20 in which the designation identification information is the same with each other, it is considered that the information which is a read target is often the same. In other words, when it is necessary to read certain information, it is considered that any of the plurality of input devices 20 in which the designation identification information is the same with each other may be read. For example, the purpose of coupling the plurality of input devices 20 in which the designation identification information is the same with each other to the communication device 100 is to prepare a plurality of units for reading the barcodes of the products. In such a case, it is considered that there is low necessity for the terminal device 200 to determine which input device 20 among the plurality of input devices 20 has read the information. Therefore, there is a possibility that it would be better to handle such a plurality of input devices 20 without distinction in the application 220 of the terminal device 200. Therefore, the communication device 100 according to the first embodiment can improve convenience.

Here, a communication device according to a comparative example is considered that does not have the configuration of the communication device 100 according to the first embodiment. In the communication device according to the comparative example, it is simply considered to establish a communication path with the application of the terminal device for each coupled input device. However, in such a case, there is a possibility that a plurality of input devices in which the designation identification information is the same with each other cannot be coupled to the communication device and used simultaneously. That is, there is a possibility that the communication device according to the comparative example assigns the device identification information only to a first coupled input device among the plurality of input devices in which the designation identification information is the same with each other to make the first coupled input device available for use. Here, in the comparative example, a countermeasure is considered in which different device identification information is assigned when the port number of the port to which the input device is coupled is different, so that a plurality of input devices in which the designation identification information is the same with each other are coupled to the communication device and used simultaneously. However, in such a case, when the input device is coupled to a port different from the port to which the input device was previously coupled, there is a concern that the device identification information different from the device identification information previously assigned is assigned. Therefore, such a countermeasure is not preferable. In addition, a countermeasure of assigning the device identification information to each serial number of the input device is also considered. However, as described above, there is a case where the input device does not have a serial number. In addition, as described above, even when the serial numbers are different, it may be preferable to handle the input devices as the same input device in the terminal device when the designation identification information is the same. Therefore, such a countermeasure is not preferable.

On the other hand, in the communication device 100 according to the first embodiment, the same device identification information is set for the plurality of input devices 20 in which the designation identification information is the same with each other. As a result, a plurality of input devices 20 in which the designation identification information is the same with each other can be coupled to the communication device and used simultaneously. Therefore, convenience is improved.

In addition, as described above, the communication device 100 according to the first embodiment performs a process for transmitting the first input information to the terminal device 200 after it is determined that the acquisition of the first input information input by the first input device 20A is completed, and then performs a process for transmitting the second input information input by the second input device 20B to the terminal device 200. As a result, even when the input information is transmitted from the plurality of input devices 20 associated with the same device identification information via the same communication path, the mixing of the input information in the communication path can be suppressed.

### Modification Example

The present disclosure is not limited to the above embodiment, and can be appropriately changed without departing from the gist. For example, the order of each process in the above-described flowcharts can be appropriately changed. In addition, each of one or more of the processes in the flowcharts described above may be omitted. Each process may be divided into a plurality of processes and executed at different timings, or a plurality of processes may be executed integrally.

In the above example, a program includes a group of commands (or software codes) for causing the computer to perform one or more functions described in the embodiment when the program is read by the computer. The program may be stored in a non-transitory computer-readable medium or a storage medium having a physical entity. As a non-limiting example, the computer-readable medium or the storage medium having a physical entity includes a Random-Access Memory (RAM), a Read-Only Memory (ROM), a flash memory, a Solid-State Drive (SSD) or other memory technique, a CD-ROM, a Digital Versatile Disk (DVD), a Blu-ray (registered trademark) disk, or other optical disk storage, a magnetic cassette, a magnetic tape, a magnetic disk storage, or other magnetic storage devices. The program may be transmitted on a transitory computer-readable medium or a communication medium. As a non-limiting example, the transitory computer-readable medium or the communication medium includes electrical, optical, acoustic, or other forms of propagating signals. The program is included in a program product.

What is claimed is:

1. A communication device comprising:
a communication processing section that performs a process for communicating with a first input device and a second input device, which are input devices to which input information is input and which are coupled to the communication device;
a setting section that sets first device identification information used in a service of the communication device for the first input device based on first identification information designated by a manufacturer for the first input device;
an acquisition section that acquires first input information which is input information input by the first input device; and
a transmission processing section that performs a process for transmitting the acquired first input information to a terminal device as input information from an input device corresponding to the first device identification information, wherein
the setting section sets the first device identification information for the second input device based on comparison between second identification information designated by a manufacturer for the second input device and the first identification information,
the acquisition section acquires second input information which is input information input by the second input device, and
the transmission processing section performs a process for transmitting the acquired second input information to the terminal device as the input information from the input device corresponding to the first device identification information.

2. The communication device according to claim 1, wherein
the transmission processing section performs a process for transmitting the first input information to the terminal device after it is determined that acquisition of the first input information input by the first input device is completed, and then performs a process for transmitting the second input information input by the second input device to the terminal device.

3. The communication device according to claim 1, wherein
the transmission processing section performs a process for transmitting a serial number of at least one of the first input device and the second input device and input information to the terminal device.

4. The communication device according to claim 1, wherein
the transmission processing section performs a process for transmitting an instruction to notify the terminal device of information on an input device associated with the first device identification information to the terminal device.

5. The communication device according to claim 1, wherein
the setting section sets second device identification information, which is device identification information different from the first device identification information, for a third input device when third identification information, which is designated by a manufacturer for the third input device that is the input device and is coupled to the communication device, is different from the first identification information.

6. The communication device according to claim 1, wherein
the setting section sets the first device identification information for the second input device when the second identification information matches the first identification information.

7. The communication device according to claim 1, wherein
each of the first identification information and the second identification information includes at least one of a vendor ID and a product ID.

8. The communication device according to claim 1, wherein
the setting section establishes a first communication path corresponding to the first device identification information between the first input device and the terminal device,
the transmission processing section performs a process for transmitting the first input information to the terminal device via the first communication path, and
the transmission processing section performs a process for transmitting the second input information to the terminal device via the first communication path.

9. A communication method executed by a communication device, the method comprising:
performing a process for communicating with a first input device and a second input device, which are input devices to which input information is input and which are coupled to the communication device;
setting first device identification information used in a service of the communication device for the first input device based on first identification information designated by a manufacturer for the first input device;
acquiring first input information which is input information input by the first input device;
performing a process for transmitting the acquired first input information to a terminal device as input information from an input device corresponding to the first device identification information;
setting the first device identification information for the second input device based on comparison between second identification information designated by a manufacturer for the second input device and the first identification information;
acquiring second input information which is input information input by the second input device; and
performing a process for transmitting the acquired second input information to the terminal device as the input information from the input device corresponding to the first device identification information.

10. A non-transitory computer-readable storage medium storing a program executed by a communication device, the program causing a computer to execute:
a step of performing a process for communicating with a first input device and a second input device, which are input devices to which input information is input and which are coupled to the communication device;
a step of setting first device identification information used in a service of the communication device for the first input device based on first identification information designated by a manufacturer for the first input device;
a step of acquiring first input information which is input information input by the first input device;
a step of performing a process for transmitting the acquired first input information to a terminal device as input information from an input device corresponding to the first device identification information;
a step of setting the first device identification information for the second input device based on comparison between second identification information designated by a manufacturer for the second input device and the first identification information;
a step of acquiring second input information which is input information input by the second input device; and
a step of performing a process for transmitting the acquired second input information to the terminal device as the input information from the input device corresponding to the first device identification information.
